(19) United States
(12) Patent Application Publication
(10) Pub. No.: US 2026/0088217 A1
(43) Pub. Date: Mar. 26, 2026

(54) SIGNAL TRANSMISSION CIRCUIT BETWEEN SUBSTRATES

(71) Applicant: NATIONAL TAIWAN UNIVERSITY, Taipei (TW)

(72) Inventors: TZONG-LIN WU, Taipei (TW); KE-HAN LIN, Taipei (TW); CHENG-WU TING, Taipei (TW)

(21) Appl. No.: 18/948,122

(22) Filed: Nov. 14, 2024

(30) Foreign Application Priority Data
Sep. 26, 2024 (TW) 113136755

(51) Int. Cl. H02J 50/70; H02J 50/00

(52) U.S. Cl. CPC H01F 38/14; H02J 50/70

(57) ABSTRACT

The disclosure provides a signal transmission circuit between substrates, which includes a first substrate and a second substrate. The first substrate comprises a first conductor, a first reference metal surface and a plurality of first connection holes. The first reference metal surface surrounds the periphery of the first conductor. The first connection holes are provided in the body of the first substrate and connected to the first reference metal surface. The second substrate comprises a second conductor, a second reference metal surface, and a plurality of second connection holes. The second reference metal surface surrounds the periphery of the second conductor. The second connection holes are provided in the body of the second substrate and connected to the second reference metal surface. Signals are wirelessly transmitted between the first substrate and the second substrate through an electromagnetic coupling between the first conductor and the second conductor.

This non-provisional application claims priority claim under 35 U.S.C. § 119(a) on Taiwan Patent Application No. 113136755 filed Sep. 26th, 2024, the entire contents of which are incorporated herein by reference.

### FIELD OF THE INVENTION

The present disclosure is related to a signal transmission circuit between substrates, particularly to a circuit for signal transmission between substrates by an electromagnetic coupling.

### BACKGROUND

With the advancement of technology, today's electronic devices usually have many functions. In order to provide those functions, multiple functional substrates are usually provided inside electronic devices. In the past, a substrate was electrically connected to another substrate through an external signal transmission line, so that signals could be transmitted between the substrates through the external signal transmission line. However, signal transmission through external signal transmission lines is not only prone to interference during signal transmission, but also requires extra space to install external signal transmission lines.

Furthermore, with the advancement of semiconductor manufacturing processes, signals can also be transmitted between substrates through an intermediate board. Referring to FIG. 1, there is shown a structural diagram of a signal transmission circuit between substrates in prior art. As shown in FIG. 1, the signal transmission circuit 100 comprises at least two structures 11, 13 and a carrier board (also referred to as an intermediate board) 15. Each of structures 11, 13 is electrically connected to the carrier board 15 through a plurality of solder balls 12. The structure 11 performs signal transmission with another substrate 13 through the conductive connection holes and/or traces in the carrier board 15.

Signal transmission between substrates 11 and 13 is facilitated by the intermediate board; however, the transmitted signals are susceptible to interference from the structural composition of the intermediate board, resulting in attenuation of the signal energy. Referring to FIG. 2, there is shown a waveform diagram of measuring a reflection loss and an insertion loss of the signal transmission circuit between the substrates shown in FIG. 1. As shown in FIG. 2, a reflection loss curve 201 and an insertion loss curve 202 can be obtained by measuring the reflection loss |S11| and the insertion loss |S21| of the signal transmission circuit 100 by using a measurement device. Ideally, when signals are transmitted, the insertion loss |S21| should be as close to 0 as possible. It can be known from the insertion loss curve 202 that in the frequency band from 140 GHz to 170 GHz, the insertion loss |S21| is lower than −5 dB, which indicates that there is a significant energy loss during signal transmission. For example, when the signal transmission circuit 100 operates at a frequency of 150.75 GHz, the measured insertion loss |S21| is −5.88 dB. Accordingly, when signals are transmitted between the substrates 11, 13 through the intermediate board, there will be significant signal energy loss, which affects the quality of signal transmission.

### SUMMARY OF THE INVENTION

It is one objective of the present disclosure to provide a signal transmission circuit between substrates, which comprises a first substrate and a second substrate. The first substrate comprises a first conductor, at least one first reference metal surface, and a plurality of first connection holes. The first reference metal surface surrounds the periphery of the first conductor. The first connection holes are connected to the first reference metal surface. The second substrate comprises a second conductor, at least one second reference metal surface, and a plurality of second connection holes. The second reference metal surface surrounds the periphery of the second conductor. The second connection holes are connected to the second reference metal surface. When signals are wirelessly transmitted between the first substrate and the second substrate the electromagnetic coupling between the first conductor and the second conductor, the transmitted signal energy may leak from the first conductor or the second conductor to the edges of the first and second substrates. In order to solve the problem of leakage of the transmitted signal energy, the disclosure provides the first reference metal surface and the first connection holes that are surround the first conductor, and provides the second reference metal surface and the second connection holes that are surround the second conductor, such that the leakage of the signal energy when signals are wirelessly transmitted between the first conductor and the second conductor can be reduced through a signal blocking effect provided by the first reference metal surface, the first connection holes, the second reference metal surface, and the second connection holes.

It is other objective of the present disclosure to provide the signal transmission circuit between substrates, which comprises a first substrate and a second substrate. The first substrate comprises a first conductor, at least one first reference metal surface, a plurality of first connection holes, and a plurality of second connection holes. The first reference metal surface surrounds the periphery of the first conductor. The first connection holes are connected to the first conductor, and the second connection holes are connected to the first reference metal surface. The second substrate comprises a second conductor, at least one second reference metal surface, a plurality of third connection holes, and a plurality of fourth connection holes. The second reference metal surface surrounds the periphery of the second conductor. The third connection holes are connected to the second conductor, and the fourth connection holes are connected to the second reference metal surface. When signals are wirelessly transmitted between the first substrate and the second substrate through the electromagnetic coupling between the first conductor and the second conductor, the transmitted signal energy may leak from the first conductor or the second conductor to the edges of the first and second substrates. In order to solve the problem of leakage of the transmitted signal energy, the disclosure provides the first reference metal surface and the second connection holes surrounding the first conductor, as well as provides the first connection holes located under the first conductor; it also provides the second reference metal surface and the fourth connection holes surrounding the second conductor, as well as provides the third connection holes located under the second conductor. So, the leakage of the transmitted signal energy when signals are wirelessly transmitted between the first conductor and the second conductor can be reduced through a signal blocking effect provided by the first reference metal surface, the first connection holes, the second connection holes, the second reference metal surface, the third connection holes, and the fourth connection holes.

It is another objective of the present disclosure to provide the signal transmission circuit between substrates, which further comprises a third substrate. The first substrate and the second substrate are fixed onto the third substrate by means of adhesive, soldering, heating and pressing, or fastening. By positioning the first substrate and the second substrate on the third substrate, the first conductor of the first substrate and the second conductor of the second substrate can wirelessly transmit signals at a fixed position.

For achieving the above objectives, the present disclosure provides a signal transmission circuit between substrates, comprising: a first substrate comprising a first conductor, at least one first reference metal surface, and a plurality of first connection holes, wherein the first conductor and the at least one first reference metal surface are configured on a first surface of the first substrate, the at least one first reference metal surface surrounds the periphery of the first conductor, the plurality of first connection holes are provided in a body structure of the first substrate and connected to the at least one first reference metal surface; and a second substrate comprising a second conductor, at least one second reference metal surface, and a plurality of second connection holes, wherein the second conductor and the at least one second reference metal surface are configured on a first surface of the second substrate, the at least one second reference metal surface surrounds the periphery of the second conductor, the plurality of second connection holes are provided in a body structure of the second substrate and connected to the at least one second reference metal surface; wherein signals are wirelessly transmitted between the first substrate and the second substrate through an electromagnetic coupling between the first conductor and the second conductor.

In one embodiment of the present disclosure, wherein there is a gap between the first substrate and the second substrate.

In one embodiment of the present disclosure, wherein a dielectric material is disposed in the gap between the first substrate and the second substrate.

In one embodiment of the present disclosure, wherein the first conductor and the second conductor are T-shaped, rectangular-shaped or arbitrary-shaped conductors, respectively.

In one embodiment of the present disclosure, wherein the plurality of first connection holes or the plurality of second connection holes are metal holes or insulating holes.

In one embodiment of the present disclosure, wherein a first ground surface is configured on a second surface of the first substrate, and a second ground surface is configured on a second surface of the second substrate.

In one embodiment of the present disclosure, wherein the plurality of first connection holes are connected between the at least one first reference metal surface and the first ground surface, and the plurality of second connection holes are connected between the at least one second reference metal surface and the second ground surface.

In one embodiment of the present disclosure, the signal transmission circuit further comprising a third substrate, wherein the first substrate and the second substrate are disposed on a first surface of the third substrate.

In one embodiment of the present disclosure, wherein the first surface of the third substrate is provided with a metal conductive layer comprising a first substrate positioning area and a second substrate positioning area, the first substrate is fixed on the first substrate positioning area, the second substrate is fixed on the second substrate positioning area.

In one embodiment of the present disclosure, wherein a first ground surface is configured on a second surface of the first substrate and a second ground surface is configured on a second surface of the second substrate; when the first substrate is fixed on the first substrate positioning area and the second substrate is fixed on the second substrate positioning area, the first ground surface of the first substrate and the second ground surface of the second substrate are electrically contact with the metal conductive layer.

In one embodiment of the present disclosure, wherein a dielectric layer is configured on the first surface of the third substrate, and comprises a first substrate positioning area and a second substrate positioning area; the first substrate positioning area includes at least one first opening, and the second substrate positioning area includes at least one second opening; the at least one first opening and the at least one second opening are filled with conductive adhesive, solder, or glue; the first substrate and the second substrate are bonded to the first substrate positioning area and the second substrate positioning area, respectively, through the conductive adhesive, the solder, or the glue in the at least one first opening and the at least one second opening.

In one embodiment of the present disclosure, wherein a metal conductive layer is further configured between the dielectric layer and the first surface of the third substrate, the first opening and the second opening are connected to the metal conductive layer.

In one embodiment of the present disclosure, wherein when the first substrate is fixed on the first substrate positioning area and the second substrate is fixed on the second substrate positioning area, the first ground surface of the first substrate and the second ground surface of the second substrate are electrically connected to the metal conductive layer via the conductive adhesive or the solder in the at least one first opening and the at least one second opening.

The present disclosure provides a signal transmission circuit between substrates, comprising: a first substrate comprising a first conductor, at least one first reference metal surface, a plurality of first connection holes, and a plurality of second connection holes, wherein the first conductor and the at least one first reference metal surface are configured on a first surface of the first substrate, the at least one first reference metal surface surrounds the periphery of the first conductor, the plurality of first connection holes are provided in a body structure of the first substrate and connected to the first conductor, the plurality of second connection holes are provided in the body structure of the first substrate and connected to the at least one first reference metal surface; and a second substrate comprising a second conductor, at least one second reference metal surface, a plurality of third connection holes, and a plurality of fourth connection holes, wherein the second conductor and the at least one second reference metal surface are configured on a first surface of the second substrate, the at least one second reference metal surface surrounds the periphery of the second conductor, the plurality of third connection holes are provided in a body structure of the second substrate and connected to the second conductor, the plurality of fourth connection holes are provided in the body structure of the second substrate and connected to the at least one second reference metal surface; wherein signals are wirelessly transmitted between the first substrate and the second substrate through an electromagnetic coupling between the first conductor and the second conductor.

In one embodiment of the present disclosure, wherein the plurality of first connection holes, the plurality of second connection holes, the plurality of third connection holes, or the plurality of fourth connection holes are metal holes or insulating holes.

In one embodiment of the present disclosure, wherein the plurality of first connection holes are connected between the first conductor and the first ground surface, the plurality of second connection holes are connected between the at least one first reference metal surface and the first ground surface, the plurality of third connection holes are connected between the second conductor and the second ground surface, the plurality of fourth connection holes are connected between the at least one second reference metal surface and the second ground surface.

### BRIEF DESCRIPTION OF THE DRAWINGS

FIG. 1 is a structural diagram of a signal transmission circuit between substrates in prior art.

FIG. 2 is a waveform diagram of measuring a reflection loss and an insertion loss of the signal transmission circuit between the substrates shown in FIG. 1.

FIG. 3 is a structural top view of a signal transmission circuit between substrates according to the first embodiment of the present disclosure.

FIG. 4 is a structural cross-sectional view of a signal transmission circuit between substrates according to the first embodiment of the present disclosure.

FIG. 5 is a structural three-dimensional view of a signal transmission circuit between substrates according to the first embodiment of the present disclosure.

FIG. 6 is a schematic diagram of the signal transmission circuit between substrates of the present disclosure applied to signal transmission between chips.

FIG. 7A is an electric field distribution diagram of the conductors that are not surrounded by the reference metal surface and the connection holes.

FIG. 7B is an electric field distribution diagram of the conductors that are surrounded by the reference metal surface and the connection holes.

FIG. 8 is a waveform diagram of measuring a reflection loss and an insertion loss of the signal transmission circuit between the substrates shown in FIG. 5.

FIG. 9 is a structural top view of a signal transmission circuit between substrates according to the second embodiment of the present disclosure.

FIG. 10 is a structural cross-sectional view of a signal transmission circuit between substrates according to the second embodiment of the present disclosure.

FIG. 11 is a structural three-dimensional view of a signal transmission circuit between substrates according to the second embodiment of the present disclosure.

FIG. 12 is a waveform diagram of measuring a reflection loss and an insertion loss of the signal transmission circuit between the substrates shown in FIG. 11.

FIG. 13 is a structural top view of a signal transmission circuit between substrates according to the third embodiment of the present disclosure.

FIG. 14 is a structural cross-sectional view of a signal transmission circuit between substrates according to the third embodiment of the present disclosure.

FIG. 15 is a structural three-dimensional view of a signal transmission circuit between substrates according to the third embodiment of the present disclosure.

FIG. 16 is a waveform diagram of measuring a reflection loss and an insertion loss of the signal transmission circuit between the substrates shown in FIG. 15.

FIG. 17 is a structural top view of a third substrate according to one embodiment of the present disclosure.

FIG. 18 is a stereogram exploded view of the first substrate and the second substrate of the signal transmission circuit of the first embodiment of the present disclosure arranged on the third substrate.

FIG. 19 is a stereogram assembled view of the first substrate and the second substrate of the signal transmission circuit of the first embodiment of the present disclosure arranged on the third substrate.

FIG. 20 is a cross-sectional view of the first substrate and the second substrate of the signal transmission circuit of the first embodiment of the present disclosure arranged on the third substrate.

FIG. 21 is a waveform diagram of measuring a reflection loss and an insertion loss of the signal transmission circuit between the substrates shown in FIG. 19.

FIG. 22 is a structural top view of a third substrate according to another embodiment of the present disclosure.

FIG. 23 is a stereogram exploded view of the first substrate and the second substrate of the signal transmission circuit of the first embodiment of the present disclosure arranged on the third substrate.

FIG. 24 is a stereogram assembled view of the first substrate and the second substrate of the signal transmission circuit of the first embodiment of the present disclosure arranged on the third substrate.

FIG. 25 is a cross-sectional view of the first substrate and the second substrate of the signal transmission circuit of the first embodiment of the present disclosure arranged on the third substrate.

FIG. 26 is a waveform diagram of measuring a reflection loss and an insertion loss of the signal transmission circuit between the substrates shown in FIG. 24.

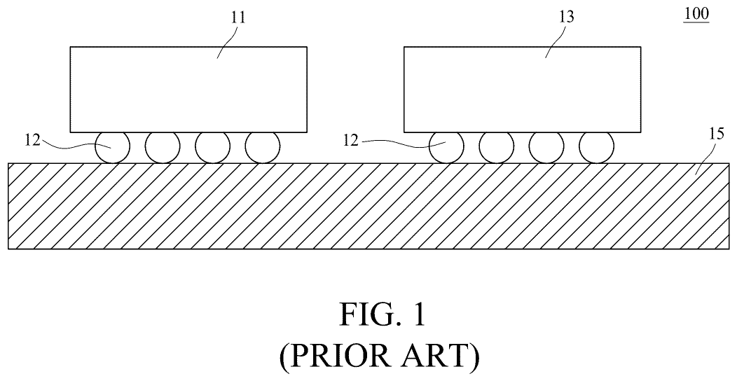

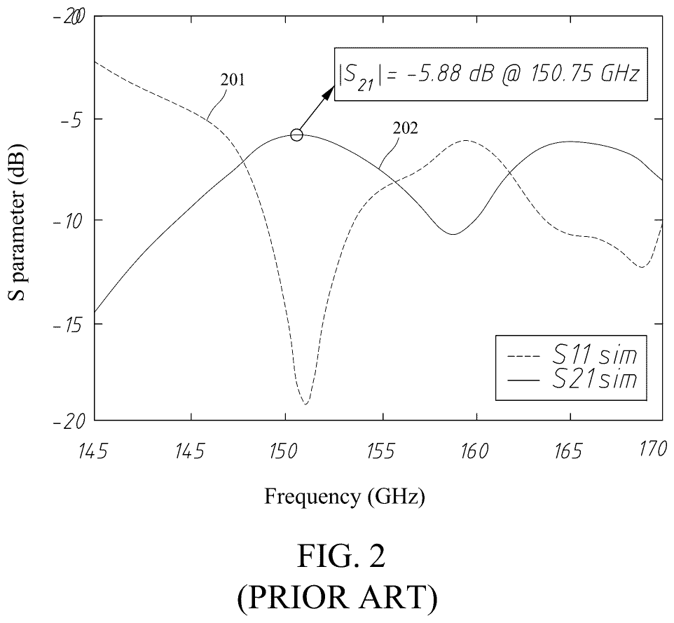

### DETAILED DESCRIPTION OF THE PREFERRED EMBODIMENTS

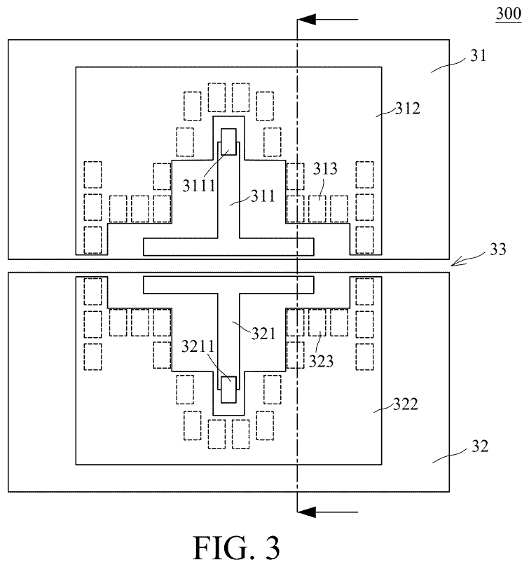

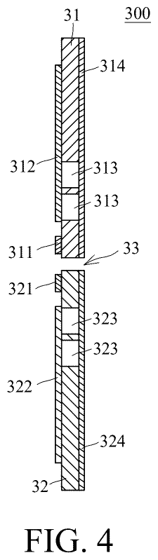

Referring to FIGS. 3, 4, and 5, there are shown a structural top view, a structural cross-sectional view, and a structural three-dimensional view of a signal transmission circuit between substrates according to the first embodiment of the present disclosure. As shown in FIGS. 3, 4, and 5, the signal transmission circuit 300 comprises a first substrate 31 and a second substrate 32.

The first substrate 31 comprises a first conductor 311, at least one first reference metal surface 312, a plurality of first connection holes 313, and a first ground surface 314. The first conductor 311 and the first reference metal surface 312 are configured on a first surface (such as the upper surface) of the first substrate 31. The first reference metal surface 312 surrounds the periphery of the first conductor 311, and is not electrically connected with the first conductor 311. The first ground surface 314 is configured on a second surface (such as the bottom surface) of the first substrate 31. The first surface and the second surface of the first substrate 31 are two opposing surfaces. The first connection holes 313 are provided in a body structure of the first substrate 31. In one embodiment of the present disclosure, the first connection holes 313 are blind holes, one end of which is connected to the first reference metal surface 312. In another embodiment of the present disclosure, the first connection holes 313 are through holes, which are connected between the first reference metal surface 312 and the first ground surface 314. Besides, the first connection holes 313 can be conductive metal holes or insulating holes that are non-conductive.

The second substrate 32 comprises a second conductor 321, at least one second reference metal surface 322, a plurality of second connection holes 323, and a second ground surface 324. The second conductor 321 and the second reference metal surface 322 are configured on a first surface (such as the upper surface) of the second substrate 32. The second reference metal surface 322 surrounds the periphery of the second conductor 321, and is not electrically connected with the second conductor 321. The second ground surface 324 is configured on a second surface (such as the bottom surface) of the second substrate 32. The first surface and the second surface of the second substrate 32 are two opposing surfaces. The second connection holes 323 are provided in a body structure of the second substrate 32. In one embodiment of the present disclosure, the second connection holes 323 are blind holes, one end of which is connected to the second reference metal surface 322. In another embodiment of the present disclosure, the second connection holes 323 are through holes, which are connected between the second reference metal surface 322 and the second ground surface 324. Besides, the second connection holes 323 can be conductive metal holes or insulating holes that are non-conductive. Furthermore, in the present embodiment, the first conductor 311 and the second conductor 321 are T-shaped conductors.

There is a gap 33 between the first substrate 31 and the second substrate 32. A dielectric material is disposed in the gap 33. Otherwise, the gap 33 may be a hollow space. Alternatively, the first substrate 31 and the second substrate 32 may be positioned closely together without any gap 33.

When the signal transmission circuit 300 operates, the first conductor 311 will be electromagnetically coupled with the second conductor 321. Signals can be wirelessly transmitted between the first substrate 31 and the second substrate 32 through the electromagnetic coupling between the first conductor 311 and the second conductor 321. Specifically, the first substrate 31 and the second substrate 32 are placed in a horizontal direction when actually installed, and signals are wirelessly transmitted in the horizontal direction through the electromagnetic coupling between the first conductor 311 and the second conductor 321. Besides, the first substrate 31 and the second substrate 32 do not overlap in the vertical extension direction.

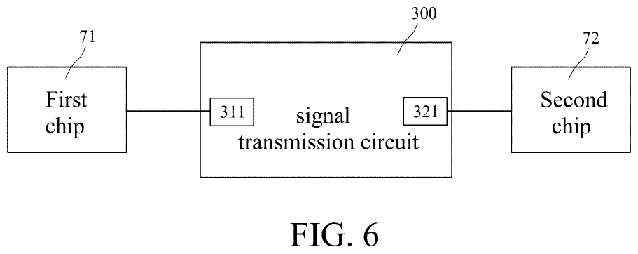

Further, referring to FIG. 6, the signal transmission circuit 300 is applied to signal transmission between a first chip 71 and a second chip 72. The first conductor 311 of the first substrate 31 is electrically connected to the first chip 71, and the second conductor 321 of the second substrate 32 is electrically connected to the second chip 72. The signal transmitted by the signal transmission circuit 300 can be a data signal, a command signal or an energy signal. When the first chip 71 wants to transmit a signal to the second chip 72, the first chip 71 can wirelessly transmit the signal to the second chip 72 through the electromagnetic coupling between the first conductor 311 and the second conductor 321 of the signal transmission circuit 300.

Besides, when the signal is wirelessly transmitted through electromagnetic coupling between the first conductor 311 and the second conductor 321, the transmitted signal energy may leak from the first conductor 311 and the second conductor 321 to the edges of the first and second substrates 31 and 32, resulting in the transmitted signal energy being unable to be concentrated between the first conductor 311 and the second conductor 321. In order to solve the problem of leakage of the transmitted signal energy, the disclosure provides the first reference metal surface 312 and the first connection holes 313 that are surround the first conductor 311, and provides the second reference metal surface 322 and the second connection holes 323 that are surround the second conductor 321, such that the leakage of the signal energy when signals are wirelessly transmitted between the first conductor 311 and the second conductor 321 can be reduced through a signal blocking effect provided by the first reference metal surface 312, the first connection holes 313, the second reference metal surface 322, and the second connection holes 323.

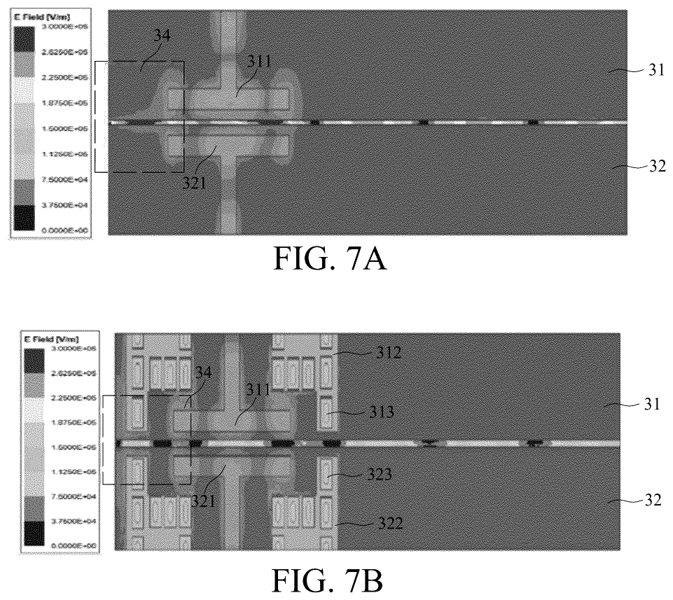

Referring to FIG. 7A and FIG. 7B, there are shown an electric field distribution diagram of the conductors that are not surrounded by the reference metal surface and the connection holes, and an electric field distribution diagram of the conductors that are surrounded by the reference metal surface and the connection holes, respectively. As shown in FIG. 7A, the first conductor 311 and the second conductor 321 that are not surrounded by any reference metal surface and any connection holes. When the signals are wirelessly transmitted between the first conductor 311 and the second conductor 321, the signal energy obviously leaks to the edges of the substrates 31 and 32 along the two conductors 311 and 321. The electric field intensity measured in an edge area 34 of the substrates 31 and 32 is 3×105 V/m.

As shown in FIG. 7B, the first conductor 311 are surrounded by the first reference metal surface 312 and the first connection holes 313, and the second conductor 321 are the second reference metal surface 322 and the second connection holes 323. When signals are wirelessly transmitted between the first conductor 311 and the second conductor 321, the signal energy will concentrate between the first conductor 311 and the second conductor 321 due to the signal blocking effect provided by the first reference metal surface 312, the first connection holes 313, the second reference metal surface 322, and the second connection holes 323, without significant leakage to the edges of substrates 31 and 32. By the signal blocking effect provided by the first reference metal surface 312, the first connection holes 313, the second reference metal surface 322, and the second connection holes 323, the electric field intensity measured in the edge area 34 of the substrates 31 and 32 will decrease from 3×10⁵ V/m to 1.5×10⁵ V/m.

Accordingly, through the signal blocking effect provided by the first reference metal surface 312, the first connection holes 313, the second reference metal surface 322, and the second connection holes 323, the leakage of the signal energy can be reduced when the signals are wirelessly transmitted between the first conductor 311 and the second conductor 321. This enables the signal energy to concentrate between the first conductor 311 and the second conductor 321, thereby improving the quality of signal transmission.

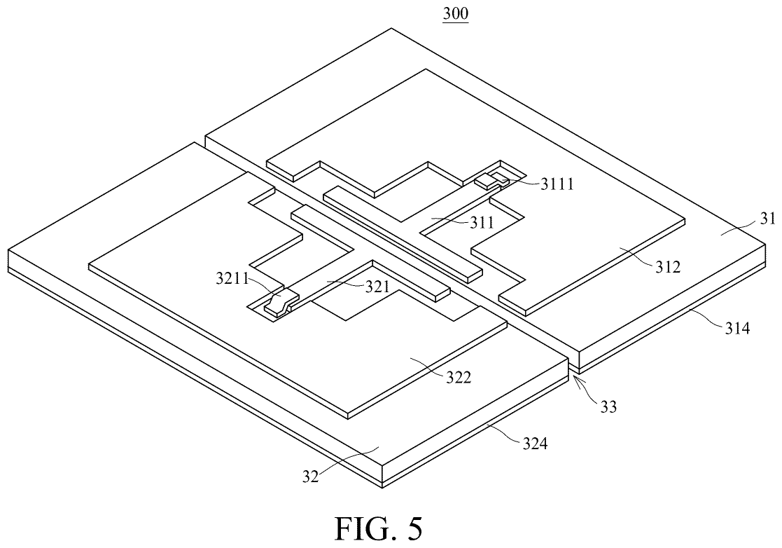

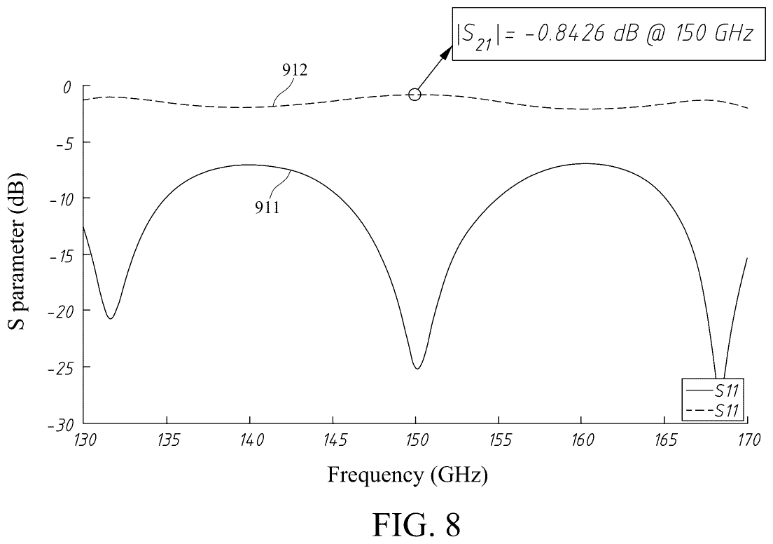

Referring to FIG. 8, there is a waveform diagram of measuring a reflection loss and an insertion loss of the signal transmission circuit between the substrates shown in FIG. 5. As shown in FIG. 5, at least one measuring point 3111 is provided on the first conductor 311, and at least one measurement point 3211 is provided on the second conductor 321. As shown in FIGS. 5 and 8, a reflection loss curve 911 and an insertion loss curve 912 can be obtained by measuring the reflection loss |S11| and the insertion loss |S21| at the measuring points 3111 and 3211 of the signal transmission circuit 300 by using a measurement device.

In the measured frequency band of 130 GHz to 170 GHz, the insertion loss curve 912 approaches 0. For example, at a frequency of 150 GHz, the measured insertion loss |S21| is 0.8426 dB. From the measured insertion loss curve 912, it can be known that when the signal transmission circuit 300 transmits signals in wireless, the loss of the signal energy is very low, and the signal transmission quality is significantly better.

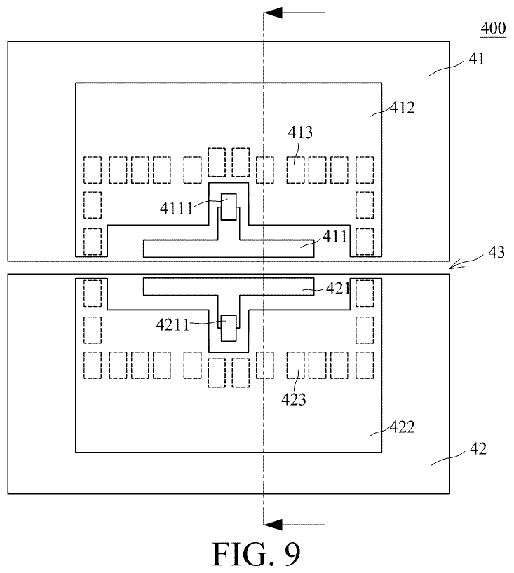

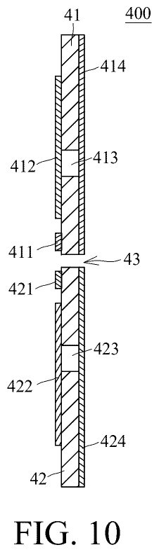

Referring to FIGS. 9, 10, and 11, there are shown a structural top view, a structural cross-sectional view, and a structural three-dimensional view of a signal transmission circuit between substrates according to the second embodiment of the present disclosure. As shown in FIGS. 9, 10, and 11, the signal transmission circuit 400 comprises a first substrate 41 and a second substrate 42.

The first substrate 41 comprises a first conductor 411, at least one first reference metal surface 412, a plurality of first connection holes 413, and a first ground surface 414. The first conductor 411 and the first reference metal surface 412 are configured on a first surface (such as the upper surface) of the first substrate 41. The first reference metal surface 412 surrounds the periphery of the first conductor 411, and is not electrically connected with the first conductor 411. The first ground surface 414 is configured on a second surface (such as the bottom surface) of the first substrate 41. The first surface and the second surface of the first substrate 41 are two opposing surfaces. The first connection holes 413 are provided in a body structure of the first substrate 41. In one embodiment of the present disclosure, the first connection holes 413 are blind holes, one end of which is connected to the first reference metal surface 412. In another embodiment of the present disclosure, the first connection holes 413 are through holes, which are connected between the first reference metal surface 412 and the first ground surface 414. Besides, the first connection holes 413 can be conductive metal holes or insulating holes that are non-conductive.

The second substrate 42 comprises a second conductor 421, at least one second reference metal surface 422, a plurality of second connection holes 423, and a second ground surface 424. The second conductor 421 and the second reference metal surface 422 are configured on a first surface (such as the upper surface) of the second substrate 42. The second reference metal surface 422 surrounds the periphery of the second conductor 421, and is not electrically connected with the second conductor 421. The second ground surface 424 is configured on a second surface (such as the bottom surface) of the second substrate 42. The first surface and the second surface of the second substrate 42 are two opposing surfaces. The second connection holes 423 are provided in a body structure of the second substrate 42. In one embodiment of the present disclosure, the second connection holes 423 are blind holes, one end of which is connected to the second reference metal surface 422. In another embodiment of the present disclosure, the second connection holes 423 are through holes, which are connected between the second reference metal surface 422 and the second ground surface 424. Besides, the second connection holes 423 can be conductive metal holes or insulating holes that are non-conductive. Furthermore, in the present embodiment, the first conductor 411 and the second conductor 421 are rectangular-shaped conductors or approximately rectangular-shaped conductors.

There is a gap 43 between the first substrate 41 and the second substrate 42. A dielectric material is disposed in the gap 43. Otherwise, the gap 43 may be a hollow space. Alternatively, the first substrate 41 and the second substrate 42 may be positioned closely together without any gap 43.

Similarly, the signal transmission circuit 400 of this present embodiment can also be applied to signal transmission between the first chip 71 and the second chip 72. The first chip 71 can wirelessly transmit signals to the second chip 72 through the electromagnetic coupling between the first conductor 411 and the second conductor 421 of the signal transmission circuit 400.

When the signal transmission circuit 400 operates, the first conductor 411 will be electromagnetically coupled with the second conductor 421. Signals can be wirelessly transmitted between the first substrate 41 and the second substrate 42 through the electromagnetic coupling between the first conductor 411 and the second conductor 421. Specifically, the first substrate 41 and the second substrate 42 are placed in a horizontal direction when actually installed, and signals are wirelessly transmitted in the horizontal direction through the electromagnetic coupling between the first conductor 411 and the second conductor 421. Besides, the first substrate 41 and the second substrate 42 do not overlap in the vertical extension direction.

Besides, when the signal is wirelessly transmitted through electromagnetic coupling between the first conductor 411 and the second conductor 421, the transmitted signal energy may leak from the first conductor 411 or the second conductor 421 to the edges of the first and second substrates 41 and 42, resulting in the transmitted signal energy being unable to be concentrated between the first conductor 411 and the second conductor 421. In order to solve the problem of leakage of the transmitted signal energy, the disclosure provides the first reference metal surface 412 and the first connection holes 413 that are surround the first conductor 411, and provides the second reference metal surface 422 and the second connection holes 423 that are surround the second conductor 421, such that the leakage of the signal energy when signals are wirelessly transmitted between the first conductor 411 and the second conductor 421 can be reduced through a signal blocking effect provided by the first reference metal surface 412, the first connection holes 413, the second reference metal surface 422, and the second connection holes 423.

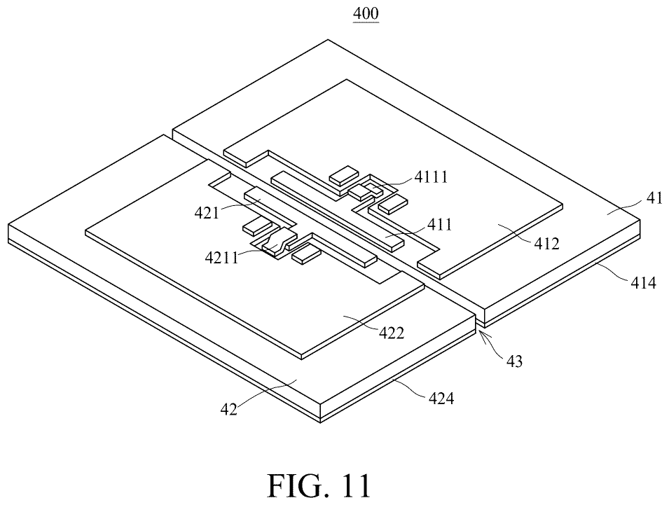

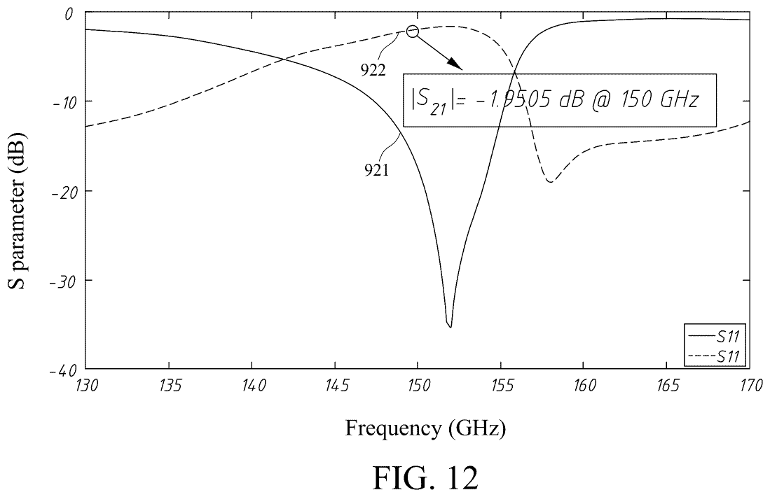

Referring to FIG. 12, there is a waveform diagram of measuring a reflection loss and an insertion loss of the signal transmission circuit between the substrates shown in FIG. 11. As shown in FIG. 11, at least one measuring point 4111 is provided on the first conductor 411, and at least one measurement point 4211 is provided on the second conductor 421. As shown in FIGS. 11 and 12, a reflection loss curve 921 and an insertion loss curve 922 can be obtained by measuring the reflection loss |S11| and the insertion loss |S21| at the measuring points 4111 and 4211 of the signal transmission circuit 400 by using a measurement device.

In the measured frequency band of 145 GHz to 155 GHz, the insertion loss curve 922 approaches 0. For example, at a frequency of 150 GHz, the measured insertion loss |S21| is 1.9505 dB. From the measured insertion loss curve 922, it can be known that when the signal transmission circuit 400 operates in the measured frequency band of 145 GHz to 155 GHz, the signal energy loss is relatively low, and the signal transmission quality is significantly better.

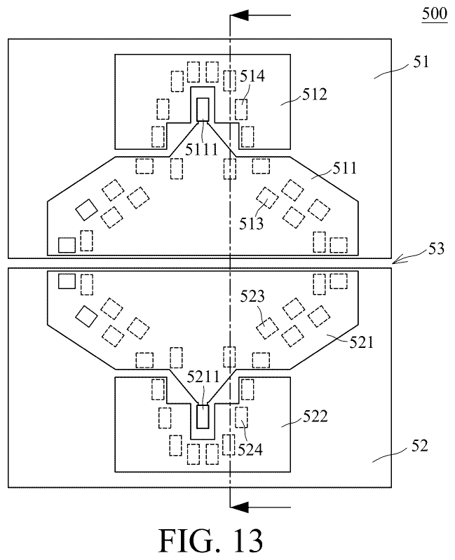

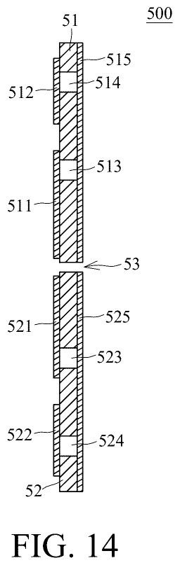

Referring to FIGS. 13, 14, and 15, there are shown a structural top view, a structural cross-sectional view, and a structural three-dimensional view of a signal transmission circuit between substrates according to the second embodiment of the present disclosure. As shown in FIGS. 13, 14, and 15, the signal transmission circuit 500 comprises a first substrate 51 and a second substrate 52.

The first substrate 51 comprises a first conductor 511, at least one first reference metal surface 512, a plurality of first connection holes 513, a plurality of second connection holes 514, and a first ground surface 515. The first conductor 511 and the first reference metal surface 512 are configured on a first surface (such as the upper surface) of the first substrate 51. The first reference metal surface 512 surrounds the periphery of the first conductor 511, and is not electrically connected with the first conductor 511. The first ground surface 515 is configured on a second surface (such as the bottom surface) of the first substrate 51. The first surface and the second surface of the first substrate 51 are two opposing surfaces. The first connection holes 513 and the second connection holes 514 are provided in a body structure of the first substrate 51. In one embodiment of the present disclosure, the first connection holes 513 and the second connection holes 514 are blind holes; one end of the first connection holes 513 is connected to the first conductor 511, while one end of the second connection holes 514 is connected to the first reference metal surface 512. In another embodiment of the present disclosure, the first connection holes 513 and the second connection holes 514 are through holes; the first connection holes 513 are connected between the first conductor 511 and the first ground surface 515, while the second connection holes 514 are connected between the first reference metal surface 512 and the first ground surface 515. Besides, the first connection holes 513 and the second connection holes 514 can be conductive metal holes or insulating holes that are non-conductive.

The second substrate 52 comprises a second conductor 521, at least one second reference metal surface 522, a plurality of third connection holes 523, a plurality of fourth connection holes 524, and a second ground surface 525. The second conductor 521 and the second reference metal surface 522 are configured on a first surface (such as the upper surface) of the second substrate 52. The second reference metal surface 522 surrounds the periphery of the second conductor 521, and is not electrically connected with the second conductor 521. The second ground surface 525 is configured on a second surface (such as the bottom surface) of the second substrate 52. The first surface and the second surface of the second substrate 52 are two opposing surfaces. The third connection holes 523 and the fourth connection holes 524 are provided in a body structure of the second substrate 52. In one embodiment of the present disclosure, the third connection holes 523 and the fourth connection holes 524 are blind holes; one end of third connection holes 523 is connected to the second conductor 521, while one end of the fourth connection holes 524 is connected to the second reference metal surface 522. In another embodiment of the present disclosure, the third connection holes 523 and the fourth connection holes 524 are through holes; the third connection holes 523 are connected between the second conductor 521 and the second ground surface 525, while the fourth connection holes 524 are connected between the second reference metal surface 522 and the second ground surface 525. Besides, the third connection holes 523 and the fourth connection holes 524 can be conductive metal holes or insulating holes that are non-conductive. Furthermore, in the present embodiment, the first conductor 511 and the second conductor 512 are arbitrary-shaped conductors.

There is a gap 53 between the first substrate 51 and the second substrate 52. A dielectric material is disposed in the gap 53. Otherwise, the gap 53 may be a hollow space. Alternatively, the first substrate 51 and the second substrate 52 may be positioned closely together without any gap 53.

Similarly, the signal transmission circuit 500 of this present embodiment can also be applied to signal transmission between the first chip 71 and the second chip 72. The first chip 71 can wirelessly transmit signals to the second chip 72 through the electromagnetic coupling between the first conductor 511 and the second conductor 521 of the signal transmission circuit 500.

When the signal transmission circuit 500 operates, the first conductor 511 will be electromagnetically coupled with the second conductor 521. Signals can be wirelessly transmitted between the first substrate 51 and the second substrate 52 through the electromagnetic coupling between the first conductor 511 and the second conductor 512. Specifically, the first substrate 51 and the second substrate 52 are placed in a horizontal direction when actually installed, and signals are wirelessly transmitted in the horizontal direction through the electromagnetic coupling between the first conductor 511 and the second conductor 521. Besides, the first substrate 51 and the second substrate 52 do not overlap in the vertical extension direction.

Besides, when the signal is wirelessly transmitted through electromagnetic coupling between the first conductor 511 and the second conductor 521, the transmitted signal energy may leak from the first conductor 511 or the second conductor 521 to the edges of the first and second substrates 51 and 52, resulting in the transmitted signal energy being unable to be concentrated between the first conductor 511 and the second conductor 521. In order to solve the problem of leakage of the transmitted signal energy, the disclosure provides the first reference metal surface 512 and the second connection holes 514 surrounding the first conductor 511, as well as provides the first connection holes 513 located under the first conductor 511; it also provides the second reference metal surface 522 and the fourth connection holes 524 surrounding the second conductor 521, as well as provides the third connection holes 523 located under the second conductor 521. So, the leakage of the signal energy when signals are wirelessly transmitted between the first conductor 511 and the second conductor 521 can be reduced through a signal blocking effect provided by the first reference metal surface 512, the first connection holes 513, the second connection holes 514, the second reference metal surface 522, the third connection holes 523, and the fourth connection holes 524.

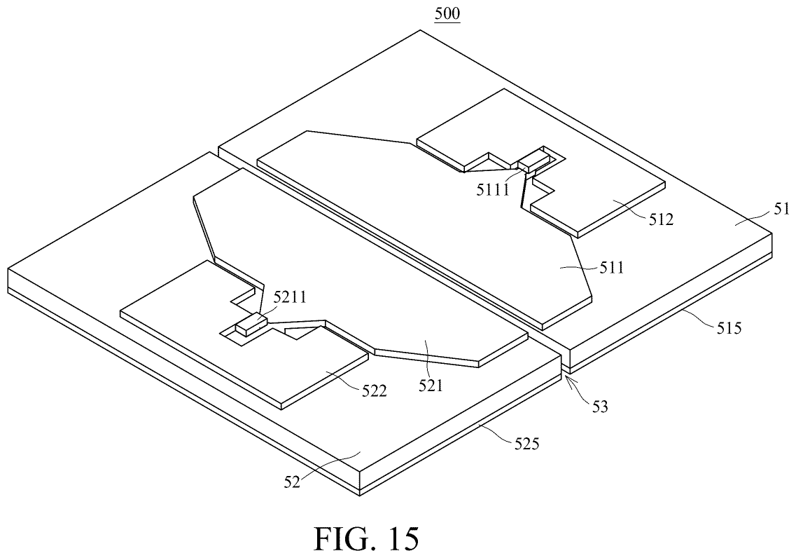

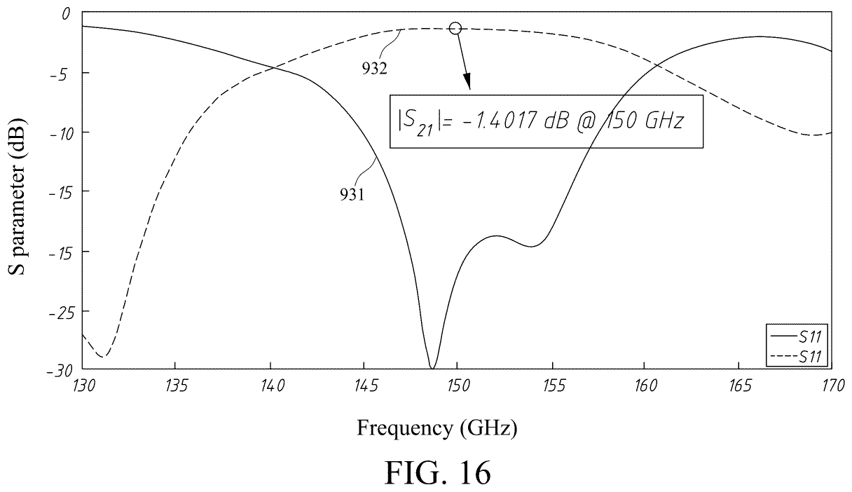

Referring to FIG. 16, there is a waveform diagram of measuring a reflection loss and an insertion loss of the signal transmission circuit between the substrates shown in FIG. 15. As shown in FIG. 15, at least one measuring point 5111 is provided on the first conductor 511, and at least one measurement point 5211 is provided on the second conductor 521. As shown in FIGS. 15 and 16, a reflection loss curve 931 and an insertion loss curve 932 can be obtained by measuring the reflection loss |S11| and the insertion loss |S21| at the measuring points 5111 and 5211 of the signal transmission circuit 500 by using a measurement device.

In the measured frequency band of 145 GHz to 155 GHz, the insertion loss curve 932 approaches 0. For example, at a frequency of 150 GHz, the measured insertion loss |S21| is 1.4017 dB. From the measured insertion loss curve 932, it can be known that when the signal transmission circuit 500 operates in the measured frequency band of 145 GHz to 155 GHz, the signal energy loss is relatively low, and the signal transmission quality is significantly better.

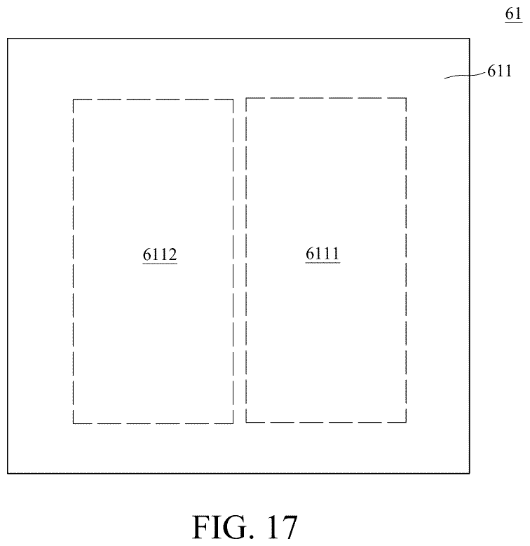

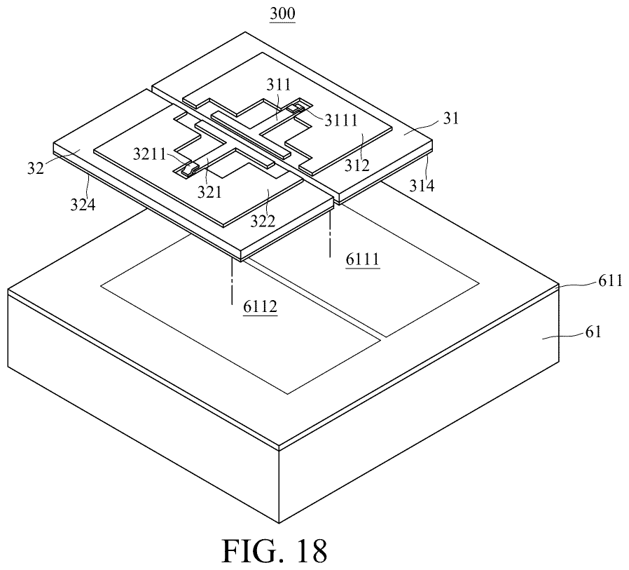

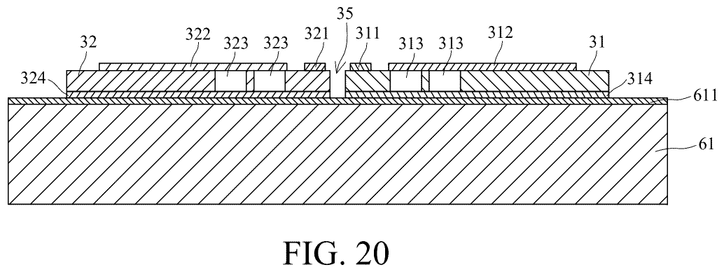

Referring to FIGS. 17, 18, 19, and 20, which respectively show a structural top view of a third substrate according to one embodiment of the present disclosure, and a stereogram exploded view, a stereogram assembled view, and a cross-sectional view of the first substrate and the second substrate of the signal transmission circuit of the first embodiment of the present disclosure arranged on the third substrate, and simultaneously referring to FIG. 5. As shown in FIGS. 5, 17, 18, 19, and 20, the first substrate 31 and the second substrate 32 of the signal transmission circuit 300 of the first embodiment can be further fixed on a third substrate 61. A first surface (such as the upper surface) of the third substrate 61 is provided with a metal conductive layer 611. The metal conductive layer 611 comprises a first substrate positioning area 6111 and a second substrate positioning area 6112. The first substrate 31 and the second substrate 32 are fixed onto the first substrate positioning area 6111 and the second substrate positioning area 6112, respectively, by means of adhesive, soldering, heating and pressing, or fastening. When the first substrate 31 is fixed onto the first substrate positioning area 6111 and the second substrate 32 is fixed onto the second substrate positioning area 6112, the first ground surface 314 of the first substrate 31 and the second ground surface 324 of the second substrate 32 are electrically contact with the metal conductive layer 611. By positioning the first substrate 31 and the second substrate 32 on the third substrate 61, the first conductor 311 of the first substrate 31 and the second conductor 321 of the second substrate 32 can wirelessly transmit signals at a fixed position.

Of course, the first substrate 41 and the second substrate 42 of the second embodiment signal transmission circuit 400 or the first substrate 51 and the second substrate 52 of the third embodiment signal transmission circuit 500 can also be fixedly on the third substrate 61. This will not be reiterated here.

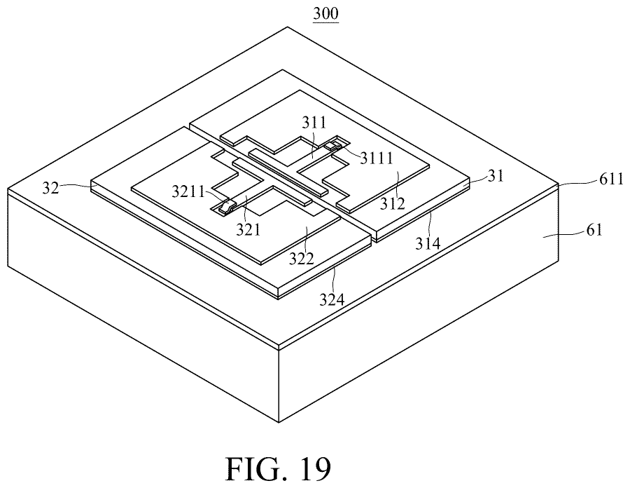

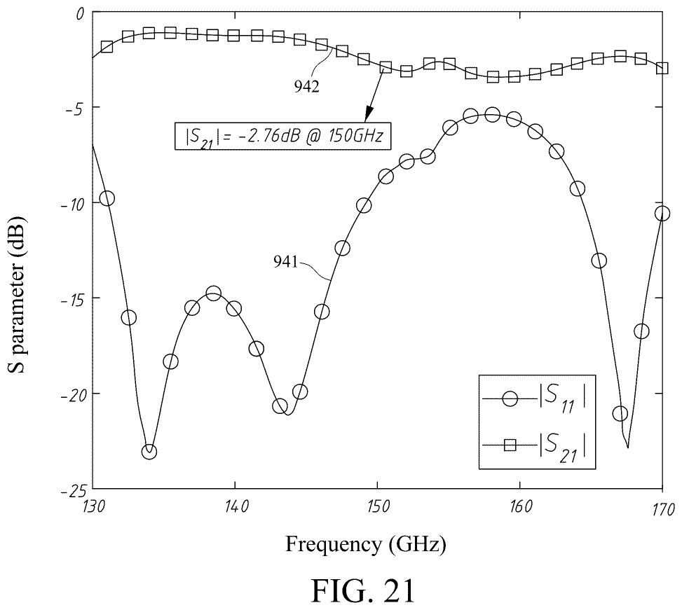

Referring to FIG. 21, there is a waveform diagram of measuring a reflection loss and an insertion loss of the signal transmission circuit between the substrates shown in FIG. 19. As shown in FIGS. 19 and 21, a reflection loss curve 941 and an insertion loss curve 942 can be obtained by measuring the reflection loss |S11| and the insertion loss |S21| at the measuring point 3111 of the first conductor 311 and the measuring point 3211 of the second conductor 321 by using a measurement device.

In the measured frequency band of 130 GHz to 170 GHz, the insertion loss curve 942 approaches 0. For example, at a frequency of 150 GHz, the measured insertion loss |S21| is 2.76 dB. From the measured insertion loss curve 942, it can be known that even if the first substrate 31 and the second substrate 32 of the signal transmission circuit 300 are further placed on the third substrate 61, the signal transmission circuit 300 still exhibits lower energy loss and better signal transmission quality during wireless signal transmission.

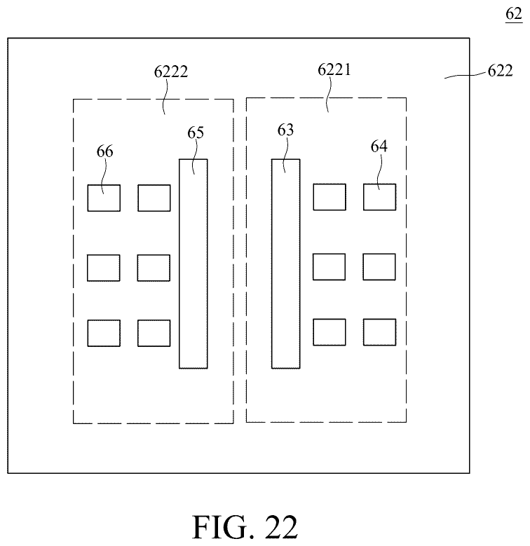

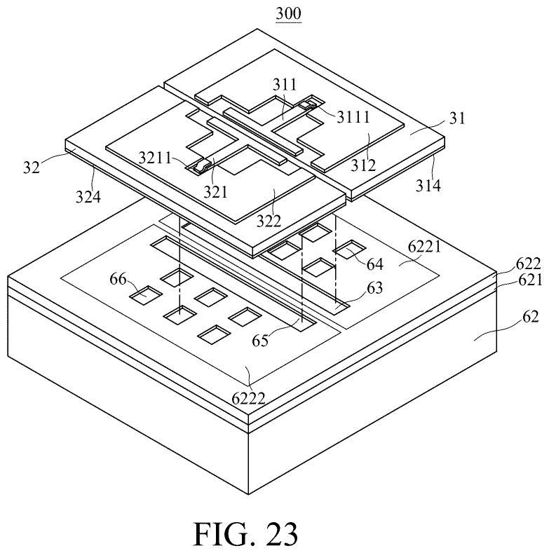

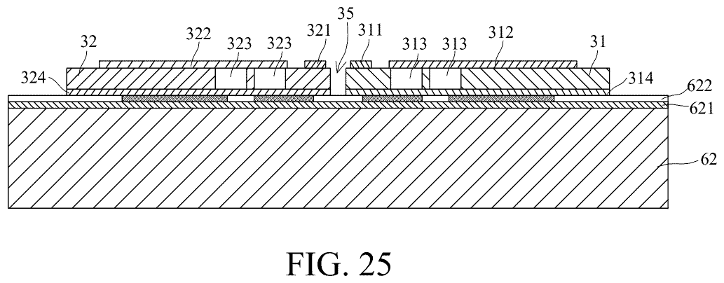

Referring to FIGS. 22, 23, 24, and 25, which respectively show a structural top view of a third substrate according to another embodiment of the present disclosure, and a stereogram exploded view, a stereogram assembled view, and a cross-sectional view of the first substrate and the second substrate of the signal transmission circuit of the first embodiment of the present disclosure arranged on the third substrate, and simultaneously referring to FIG. 5. As shown in FIGS. 5, 22, 23, 24, and 25, the first substrate 31 and the second substrate 32 of the signal transmission circuit 300 of the first embodiment can be further fixed on a third substrate 62. A first surface (such as the upper surface) of the third substrate 62 is sequentially provided with a metal conductive layer 621 and a dielectric layer 622. The dielectric layer 622 comprises a first substrate positioning area 6221 and a second substrate positioning area 6222. The first substrate positioning area 6221 includes first openings 63, 64, while the second substrate positioning area 6222 includes second openings 65, 66. The first openings 63, 64 and the second openings 65, 66 are connected to the metal conductive layer 621. The first openings 63, 64 and the second openings 65, 66 can be designed in strip shape, square shape or arbitrary shape.

The first openings 63, 64 and the second openings 65, 66 can be filled with conductive adhesive, solder, glue, or other adhesive materials. The first substrate 31 is bonded to the first substrate positioning area 6221 through the conductive adhesive, the solder, the glue or other adhesive materials in the first openings 63, 64, and the second substrate 32 is bonded to the second substrate positioning area 6222 through the conductive adhesive, the solder, the glue or other adhesive materials in the second openings 65, 66.

When the first substrate 31 is fixed on the first substrate positioning area 6221 and the second substrate 32 is fixed on the second substrate positioning area 6222, the first ground surface 314 of the first substrate 31 and the second ground surface 324 of the second substrate 32 will contact the dielectric layer 622 or/and electrically connected to the metal conductive layer 621. By positioning the first substrate 31 and the second substrate 32 on the third substrate 61, the first conductor 311 of the first substrate 31 and the second conductor 321 of the second substrate 32 can wirelessly transmit signals at a fixed position.

Of course, the first substrate 41 and the second substrate 42 of the second embodiment signal transmission circuit 400 or the first substrate 51 and the second substrate 52 of the third embodiment signal transmission circuit 500 can also be fixedly on the third substrate 62. This will not be reiterated here.

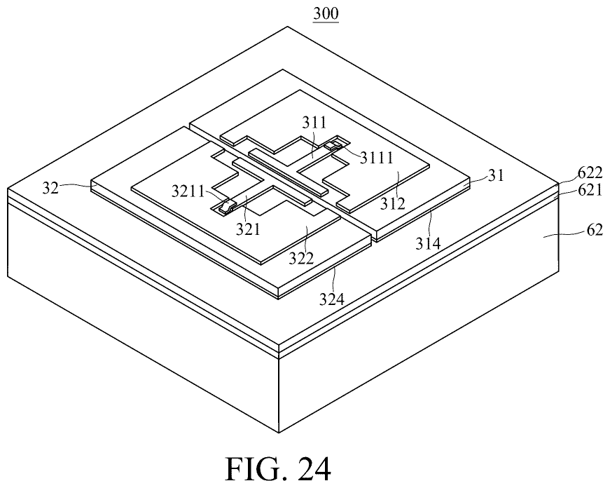

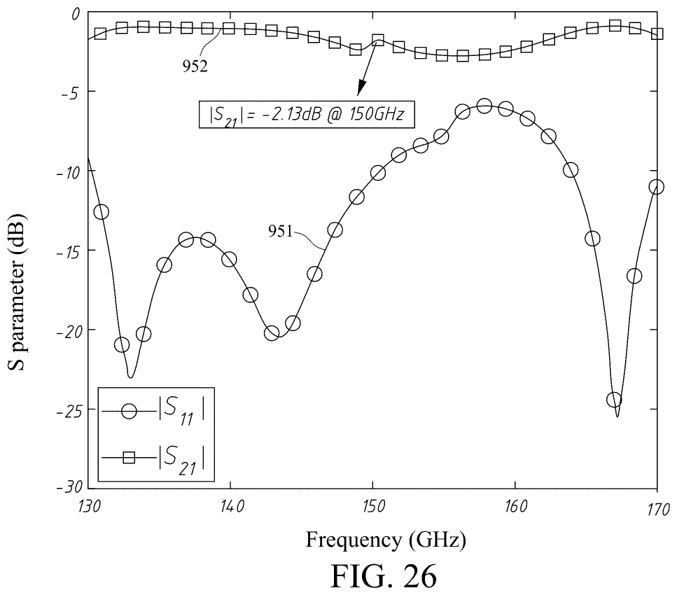

Referring to FIG. 26, there is a waveform diagram of measuring a reflection loss and an insertion loss of the signal transmission circuit between the substrates shown in FIG. 24. As shown in FIGS. 24 and 26, a reflection loss curve 951 and an insertion loss curve 952 can be obtained by measuring the reflection loss |S11| and the insertion loss |S21| at the measuring point 3111 of the first conductor 311 and the measuring point 3211 of the second conductor 321 by using a measurement device.

In the measured frequency band of 130 GHz to 170 GHz, the insertion loss curve 952 approaches 0. For example, at a frequency of 150 GHz, the measured insertion loss |S21| is 2.13 dB. From the measured insertion loss curve 952, it can be known that even if the first substrate 31 and the second substrate 32 of the signal transmission circuit 300 are further placed on the third substrate 62, the signal transmission circuit 300 still exhibits lower energy loss and better signal transmission quality during wireless signal transmission.

The above disclosure is only the preferred embodiment of the present invention, and not used for limiting the scope of the present invention. All equivalent variations and modifications on the basis of shapes, structures, features and spirits described in the claims of the present invention should be included in the claims of the present invention.

1. A signal transmission circuit between substrates, comprising:
a first substrate comprising a first conductor, at least one first reference metal surface, and a plurality of first connection holes, wherein the first conductor and the at least one first reference metal surface are configured on a first surface of the first substrate, the at least one first reference metal surface surrounds the periphery of the first conductor, the plurality of first connection holes are provided in a body structure of the first substrate and connected to the at least one first reference metal surface; and
a second substrate comprising a second conductor, at least one second reference metal surface, and a plurality of second connection holes, wherein the second conductor and the at least one second reference metal surface are configured on a first surface of the second substrate, the at least one second reference metal surface surrounds the periphery of the second conductor, the plurality of second connection holes are provided in a body structure of the second substrate and connected to the at least one second reference metal surface;
wherein signals are wirelessly transmitted between the first substrate and the second substrate through an electromagnetic coupling between the first conductor and the second conductor.

2. The signal transmission circuit between substrates according to claim 1, wherein there is a gap between the first substrate and the second substrate.

3. The signal transmission circuit between substrates according to claim 2, wherein a dielectric material is disposed in the gap between the first substrate and the second substrate.

4. The signal transmission circuit between substrates according to claim 1, wherein the first conductor and the second conductor are T-shaped, rectangular-shaped or arbitrary-shaped conductors, respectively.

5. The signal transmission circuit between substrates according to claim 1, wherein the plurality of first connection holes or the plurality of second connection holes are metal holes or insulating holes.

6. The signal transmission circuit between substrates according to claim 1, wherein a first ground surface is configured on a second surface of the first substrate, and a second ground surface is configured on a second surface of the second substrate.

7. The signal transmission circuit between substrates according to claim 6, wherein the plurality of first connection holes are connected between the at least one first reference metal surface and the first ground surface, and the plurality of second connection holes are connected between the at least one second reference metal surface and the second ground surface.

8. The signal transmission circuit between substrates according to claim 1, further comprising a third substrate, wherein the first substrate and the second substrate are disposed on a first surface of the third substrate.

9. The signal transmission circuit between substrates according to claim 8, wherein the first surface of the third substrate is provided with a metal conductive layer comprising a first substrate positioning area and a second substrate positioning area, the first substrate is fixed on the first substrate positioning area, the second substrate is fixed on the second substrate positioning area.

10. The signal transmission circuit between substrates according to claim 9, wherein a first ground surface is configured on a second surface of the first substrate and a second ground surface is configured on a second surface of the second substrate; when the first substrate is fixed on the first substrate positioning area and the second substrate is fixed on the second substrate positioning area, the first ground surface of the first substrate and the second ground surface of the second substrate are electrically contact with the metal conductive layer.

11. The signal transmission circuit between substrates according to claim 8, wherein a dielectric layer is configured on the first surface of the third substrate, and comprises a first substrate positioning area and a second substrate positioning area; the first substrate positioning area includes at least one first opening, and the second substrate positioning area includes at least one second opening; the at least one first opening and the at least one second opening are filled with conductive adhesive, solder, or glue; the first substrate and the second substrate are bonded to the first substrate positioning area and the second substrate positioning area, respectively, through the conductive adhesive, the solder, or the glue in the at least one first opening and the at least one second opening.

12. The signal transmission circuit between substrates according to claim 11, wherein a metal conductive layer is further configured between the dielectric layer and the first surface of the third substrate, the first opening and the second opening are connected to the metal conductive layer.

13. The signal transmission circuit between substrates according to claim 12, wherein when the first substrate is fixed on the first substrate positioning area and the second substrate is fixed on the second substrate positioning area, the first ground surface of the first substrate and the second ground surface of the second substrate are electrically connected to the metal conductive layer via the conductive adhesive or the solder in the at least one first opening and the at least one second opening.

14. A signal transmission circuit between substrates, comprising:
a first substrate comprising a first conductor, at least one first reference metal surface, a plurality of first connection holes, and a plurality of second connection holes, wherein the first conductor and the at least one first reference metal surface are configured on a first surface of the first substrate, the at least one first reference metal surface surrounds the periphery of the first conductor, the plurality of first connection holes are provided in a body structure of the first substrate and connected to the first conductor, the plurality of second connection holes are provided in the body structure of the first substrate and connected to the at least one first reference metal surface; and
a second substrate comprising a second conductor, at least one second reference metal surface, a plurality of third connection holes, and a plurality of fourth connection holes, wherein the second conductor and the at least one second reference metal surface are configured on a first surface of the second substrate, the at least one second reference metal surface surrounds the periphery of the second conductor, the plurality of third connection holes are provided in a body structure of the second substrate and connected to the second conductor, the plurality of fourth connection holes are provided in the body structure of the second substrate and connected to the at least one second reference metal surface;
wherein signals are wirelessly transmitted between the first substrate and the second substrate through an electromagnetic coupling between the first conductor and the second conductor.

15. The signal transmission circuit between substrates according to claim 14, wherein there is a gap between the first substrate and the second substrate.

16. The signal transmission circuit between substrates according to claim 15, wherein a dielectric material is disposed in the gap between the first substrate and the second substrate.

17. The signal transmission circuit between substrates according to claim 14, wherein the first conductor and the second conductor are T-shaped, rectangular-shaped or arbitrary-shaped conductors, respectively.

18. The signal transmission circuit between substrates according to claim 14, wherein the plurality of first connection holes, the plurality of second connection holes, the plurality of third connection holes, or the plurality of fourth connection holes are metal holes or insulating holes.

19. The signal transmission circuit between substrates according to claim 14, wherein a first ground surface is configured on a second surface of the first substrate, and a second ground surface is configured on a second surface of the second substrate.

20. The signal transmission circuit between substrates according to claim 19, wherein the plurality of first connection holes are connected between the first conductor and the first ground surface, the plurality of second connection holes are connected between the at least one first reference metal surface and the first ground surface, the plurality of third connection holes are connected between the second conductor and the second ground surface, the plurality of fourth connection holes are connected between the at least one second reference metal surface and the second ground surface.

21. The signal transmission circuit between substrates according to claim 14, further comprising a third substrate, wherein the first substrate and the second substrate are disposed on a first surface of the third substrate.

22. The signal transmission circuit between substrates according to claim 21, wherein the first surface of the third substrate is provided with a metal conductive layer comprising a first substrate positioning area and a second substrate positioning area, the first substrate is fixed on the first substrate positioning area, the second substrate is fixed on the second substrate positioning area.

23. The signal transmission circuit between substrates according to claim 22, wherein a first ground surface is configured on a second surface of the first substrate and a second ground surface is configured on a second surface of the second substrate; when the first substrate is fixed on the first substrate positioning area and the second substrate is fixed on the second substrate positioning area, the first ground surface of the first substrate and the second ground surface of the second substrate are electrically contact with the metal conductive layer.

24. The signal transmission circuit between substrates according to claim 21, wherein a dielectric layer is configured on the first surface of the third substrate, and comprises a first substrate positioning area and a second substrate positioning area; the first substrate positioning area includes at least one first opening, and the second substrate positioning area includes at least one second opening; the at least one first opening and the at least one second opening are filled with conductive adhesive, solder, or glue; the first substrate and the second substrate are bonded to the first substrate positioning area and the second substrate positioning area, respectively, through the conductive adhesive, the solder, or the glue in the at least one first opening and the at least one second opening.

25. The signal transmission circuit between substrates according to claim 24, wherein a metal conductive layer is further configured between the dielectric layer and the first surface of the third substrate, the first opening and the second opening are connected to the metal conductive layer.

26. The signal transmission circuit between substrates according to claim 25, wherein when the first substrate is fixed on the first substrate positioning area and the second substrate is fixed on the second substrate positioning area, the first ground surface of the first substrate and the second ground surface of the second substrate are electrically connected to the metal conductive layer via the conductive adhesive or the solder in the at least one first opening and the at least one second opening.
